(19) United States
(12) Patent Application Publication
(10) Pub. No.: US 2003/0112198 A1
(43) Pub. Date: Jun. 19, 2003

(54) MULTIBAND ANTENNA

(76) Inventors: Hanyang Wang, Oxfordshire (GB); Su Quing Zhang, Oxford (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/020,197

(22) Filed: Dec. 18, 2001

(51) Int. Cl. H01Q 13/10; H01Q 1/24

(52) U.S. Cl. 343/770; 343/702

(57) ABSTRACT

An antenna has at least one slotted planar element. The slot in the planar element is open at one end and configured such that the planar element has a quarter wave resonance mode at a first frequency and there is a second resonant frequency at which the element has a ¾ wave resonance mode and/or the element's slot has a quarter wave resonance mode. The second frequency is not substantially three time the first frequency. Multiple slotted elements may be employed to achieve increased

### FIELD OF THE INVENTION

The present invention relates to a multiband antenna.

### BACKGROUND TO THE INVENTION

In recent years there has been a move towards harmonising mobile phone systems throughout the world. For instance, many countries have GSM900 systems enabling users from one country to use their mobile phones in another country. However, this harmonisation has not yet been completed. For instance, spectrum availability has let to the introduction of DCS1800 which is similar to GSM900 but operates in a band in the region of 1800 MHz rather than 900 MHz as in the case of GSM. Additionally, national spectrum management authorities do not necessarily decide to allocate the same bands to the public land mobile network service. For instance, in the United States of America a DCS1800-like system (DCS1900) is implemented in a band in the region of 1900 MHz. Further incompatibilities arise during transitional periods when a new system is being introduced and an old one phased out.

### SUMMARY OF THE INVENTION

It is an object of the present invention to provide a multiband antenna that is compact.

According to the present invention, there is provided a multiband antenna comprising a doubly resonant slotted substantially planar element having an open-ended slot therein, wherein said element is slotted such that said element has a quarter wave resonance mode at a first frequency and the element has a ¾ wave resonance mode at a second frequency or the slot has a quarter wave resonance mode at a second frequency, the second frequency not being substantially three time the first frequency. The planar element need not be flat but will have a large area to thickness ratio. For instance, the planar element may be curved to conform to an overriding structural limitation. Furthermore, the planar element may have small auxiliary portions, such as supporting and/or structures.

Greater bandwidth may be obtained by including a further doubly resonant, slotted planar element having an open-ended slot therein.

Preferably, said further element is slotted such that said further element has a quarter wave resonance mode at a third frequency and the further element has ¾ wave resonance mode at a fourth frequency or its slot has a quarter wave resonance mode at a fourth frequency, the fourth frequency not being substantially three time the third frequency. More preferably, the first and third frequencies are sufficiently close to provide a single unbroken usable bandwidth and/or the second and fourth frequencies are sufficiently close to provide a single unbroken usable bandwidth. This gives a broader bandwidth.

Preferably, a feed circuit comprising an elongate signal line extends past the open ends of the or each slot.

Preferably, said planar elements are separated by a non-conductive strip into which said slots open.

Preferably, an antenna according to the present invention includes an insulating substrate, and the or each planar element is on one side of said substrate and said signal line comprises a strip on the other side of the substrate and aligned with said non-conductive strip.

Preferably, there is a ground connection to the or each slotted planar element.

### BRIEF DESCRIPTION OF THE DRAWINGS

FIG. 1 is a perspective view of an antenna according to the present invention;

FIG. 2 is a top plan view of the antenna of FIG. 1;

FIG. 3 is a bottom plan view of the antenna of FIG. 1;

FIG. 4 is an end view of the antenna of FIG. 1;

FIG. 5 illustrates the return loss characteristic of the antenna of FIG. 1; and

FIGS. 6(a) to 6(f) illustrate alternative embodiments.

### DETAILED DESCRIPTION OF THE PREFERRED EMBODIMENT

Embodiments of the present invention will now be described, by way of example, with reference to the accompanying drawings.

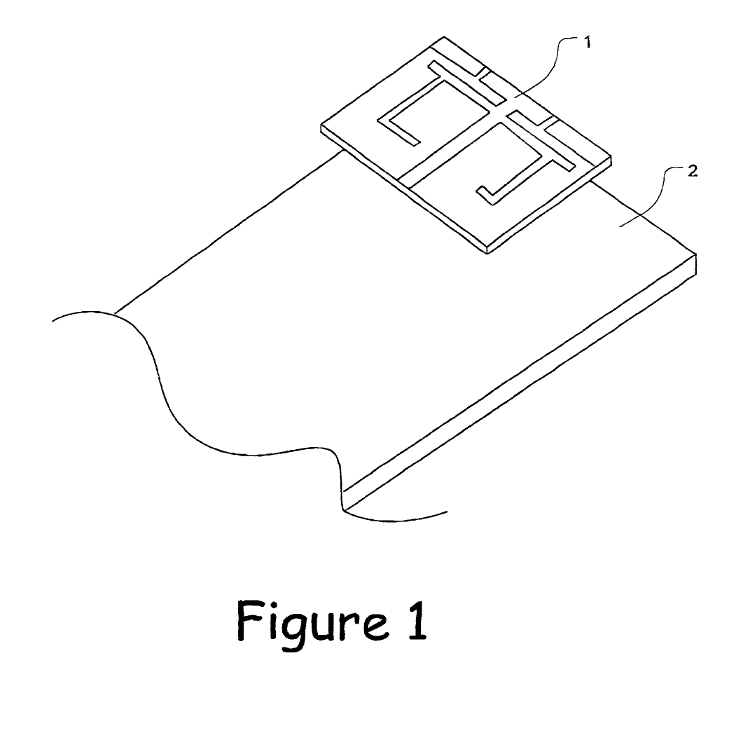

Referring to FIG. 1, an antenna 1 according to the present invention is mounted to the main printed circuit board (PCB) 2 of a radio communication device. The antenna 1 lies parallel to and is spaced perpendicularly from a major face of the main printed circuit board 2.

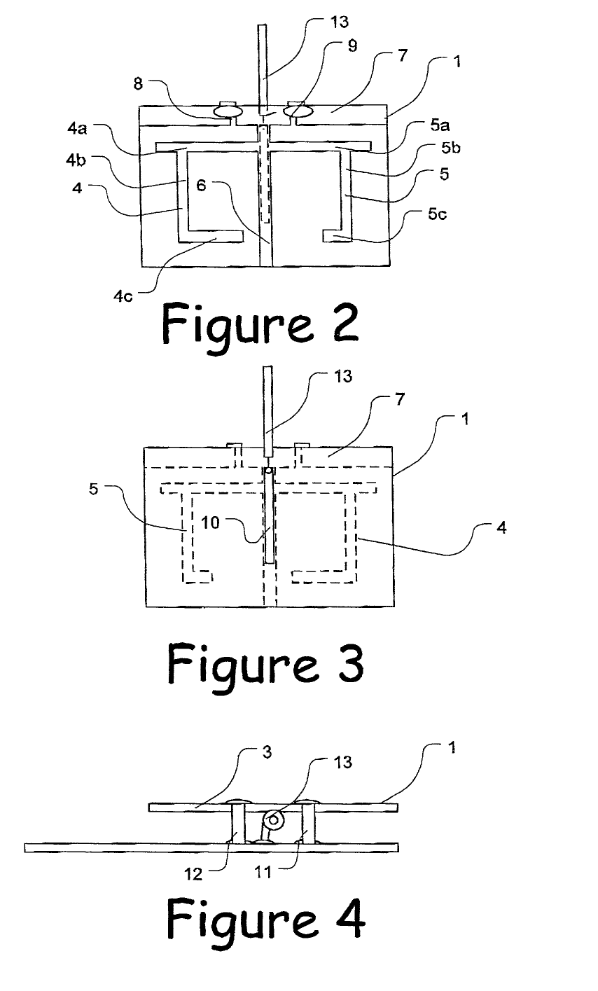

Referring to FIGS. 2 and 3, the antenna 1 comprises a substrate 3. First and second angular, substantially C-shaped, slots 4, 5 on one side of the substrate 3. The slots 4, 5 extend in opposite directions from a central strip 6, extending across the printed circuit board 3. Both the central strip and the slots 4, 5 comprise regions from which copper of a conductive layer on the substrate 3 has been removed. The copper conductor has also been removed from a margin 7 of the printed circuit board 3 which runs perpendicular to the central strip 6, save for two branches 8, 9 reaching to the edge of the substrate 3 on respective sides of the central strip 6.

The antenna's feed is provided on the other side of the substrate 3 and comprises a conductive strip 10 aligned with the central strip 6. The conductive strip 10 starts at the edge of the aforementioned margin 7.

The first slot 4 comprises a first section 4a extending parallel to the aforementioned margin 7, a second section 4b extending from a point, about two thirds of the way along the first section 4a, parallel to the central strip 6 and a third portion 4c extending towards the central strip 6 from the distal end of the second section 4b and at a right angle thereto. The first section 4a is 12 mm long, the second section 4b is 17 mm long from the edge of the first section 4a and the third section 4c is 8 mm long including the width of the second section 4b.

The second slot 5 comprises first, second and third sections 5a, 5b, 5c arranged as a mirror image of the first slot element 4 except that the third section is shorter, being only 1 mm long.

The sections 4a, 4b, 4c, 5a, 5b, 5c of the slot elements 4, 5 are all 2.5 mm wide.

The branches 8, 9 are 1 mm wide. The conductive strip 10 is 1.5 mm wide and 15.5 mm long and the central strip 6 is slightly wider. The substrate 3 is 1.5 mm thick and comprises LCP with a relative permittivity of 3.8.

Referring additionally to FIG. 4, first and second copper strips 11, 12 are soldered to respective branches 8, 9 at one end and to the ground plane of the main circuit board 2 at the other end. The core of a coaxial cable 13 is soldered to the end of the conductive strip 10, adjacent the aforementioned margin 7. The shield of the coaxial cable 13 is soldered to the ground plane of the main circuit board 2. The coaxial cable 13 connects the antenna to transmitter and receiver circuitry (not shown).

The side of the antenna 1 containing the first slot 4 acts as a quarter wave resonant element at a first frequency in the region of 950 MHz. This structure is also resonant at a second frequency in the region of 2000 MHz. At this second frequency, the structure, including the first copper strip 11 and the first branch 8, can be viewed equally as a ¾ wave resonant element or a quarter wave resonant slot. The quarter wave resonance mode of the slot may not involve the whole of the slot. It will be noted that the higher frequency is not three times the lower frequency. The ratio between the lower and higher resonant frequencies is set by the geometry of the first slot 4.

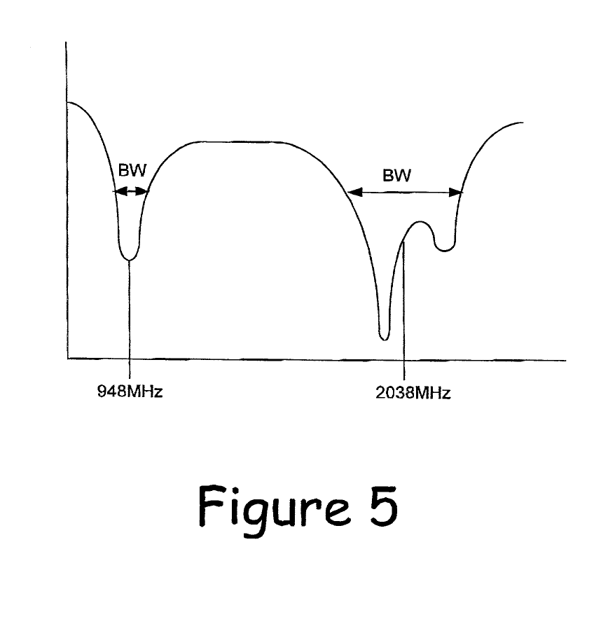

The side of the antenna 1 containing the second slot 5 resonates in a similar manner but at slightly higher frequencies. Consequently, the antenna 1 is resonant at four frequencies. However, the differences between the respective lower and upper resonant frequencies are such that the antenna 1 has two operational, unbroken 6 db bandwidths as shown in FIG. 5. In the present example, with the antenna 1 in free space, it has a lower band centred on 948 MHz with a bandwidth of 155 MHz and an upper band centred on 2038 MHz with a bandwidth of 509 MHz. Thus, the antenna 1 provides a single structure that can be used for GSM900, DCS1800, DCS1900 and WCDMA frequency bands. Furthermore, it is far smaller with a volume of 5 cm³ than an equivalent using conventional planar inverted-F antennas which would require a volume of 10 cm³.

The present invention is not restricted to the slot forms shown in FIGS. 1 to 3.

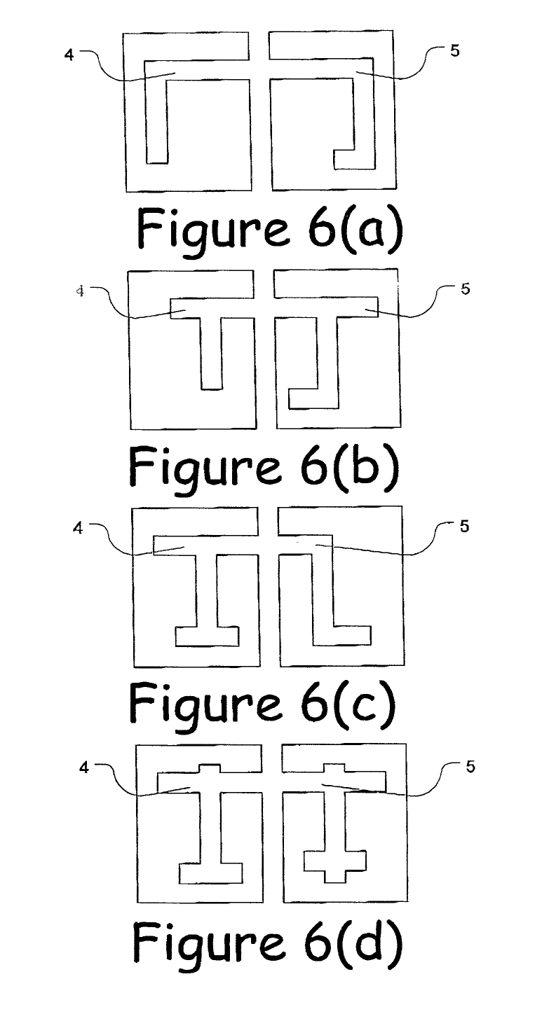

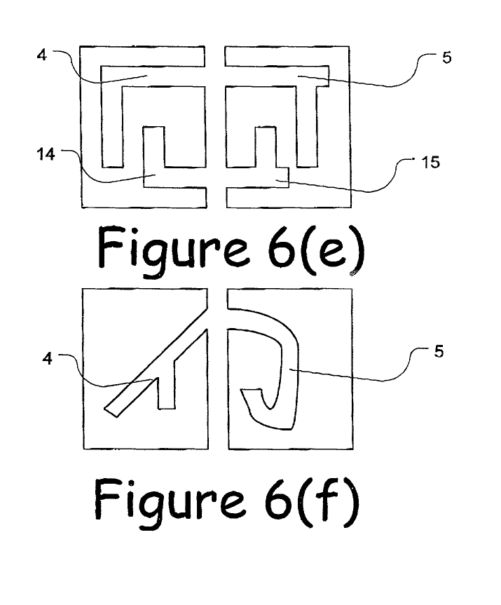

Referring to FIG. 6(a), the first slot 4 is L-shaped and the second slot 5 has an angular J shape with its shank extending perpendicularly from the central strip 6.

Referring to FIG. 6(b), the first slot 4 is T-shaped, with its cross-piece extending perpendicularly from the central strip 6, and the second slot 5 has an angular J shape with its shank extending perpendicularly from the central strip 6 and a stub extending its shank. The openings of the two slots 4, 5 into the central strip are offset a short way with respect to each other.

Referring to FIG. 6(c), the first slot 4 comprises a first portion perpendicular to the central strip 6 and a T-shaped branch and the second slot 5 has a squared Z-shape.

Referring to FIG. 6(d), the first slot 4 comprises a straight portion perpendicular to the central strip 6 and a T-shaped portion crossing the straight portion, and the second slot 5 comprises a straight portion perpendicular to the central strip 6 and a long cross shape crossing the straight portion.

Referring to FIG. 6(e), the first slot 4 is L-shaped and accompanied by a third slot 14 which is also L-shaped but oppositely arranged. The second slot 5 is L-shaped with a small stub at its heel and accompanied by a fourth slot 15 which is T-shaped with its cross piece connected to the central strip 6 and it leg extending towards the second slot 4.

Referring to FIG. 6(f) the first slot 4 is straight and extends diagonally from the central strip and has a short branch parallel to the central strip 6. The second slot 5 is curved and generally C-shaped.

It will be appreciated that many modifications may be made to the preferred embodiment described above. For instance, one half of the antenna can be dispensed with if a less broad bandwidth is required. Alternatively, the antenna could be made symmetrical to give a reduced bandwidth but better matching characteristics.

What is claimed is:

1. A multiband antenna comprising a doubly resonant slotted substantially planar element having an open-ended slot therein, wherein said element is slotted such that said element has a quarter wave resonance mode at a first frequency and ¾ wave resonance mode at a second frequency, the second frequency not being substantially three time the first frequency.

2. An antenna according to claim 1, including a ground connection to said slotted planar element.

3. An antenna according to claim 1, including a feed circuit, the feed circuit comprising an elongate signal line extending past the open end of said slot.

4. An antenna according to claim 3, including an insulating substrate, wherein said planar element is on one side of said substrate and the signal line comprises a strip on the other side of the substrate.

5. An antenna according to claim 1, including a further doubly resonant, slotted planar element having an open-ended slot therein.

6. An antenna according to claim 5, wherein said further element is slotted such that said further element has a quarter wave resonance mode at a third frequency and ¾ wave resonance mode at a fourth frequency, the fourth frequency not being substantially three time the third frequency.

7. An antenna according to claim 6, wherein the first and third frequencies are sufficiently close to provide a single unbroken usable bandwidth.

8. An antenna according to claim 6, wherein the second and fourth frequencies are sufficiently close to provide a single unbroken usable bandwidth.

9. An antenna according to claim 5, including a feed circuit, the feed circuit comprising an elongate signal line extending past the open ends of said slots.

10. An antenna according to claim 9, wherein said planar elements are separated by a non-conductive strip into which said slots open.

11. An antenna according to claim 10, including an insulating substrate, wherein said planar elements are on one side of said substrate and said signal line comprises a strip on the other side of the substrate and aligned with said non-conductive strip.

12. A multiband antenna comprising a doubly resonant slotted planar element having an open-ended slot therein, wherein said element is slotted such that said element has a quarter wave resonance mode at a first frequency and its slot has a quarter wave resonance mode at a second frequency, the second frequency not being substantially three time the first frequency.

13. An antenna according to claim 12, including a ground connection to said slotted planar element.

14. An antenna according to claim 12, including a feed circuit, the feed circuit comprising an elongate signal line extending past the open end of said slot.

15. An antenna according to claim 14, including an insulating substrate, wherein said planar element is on one side of said substrate and the signal line comprises a strip on the other side of the substrate.

16. An antenna according to claim 12, including a further doubly resonant, slotted planar element having an open-ended slot therein.

17. An antenna according to claim 16, wherein said further element is slotted such that said further element has a quarter wave resonance mode at a third frequency and said further element's slot has a quarter wave resonance mode at a fourth frequency, the fourth frequency not being substantially three time the third frequency.

18. An antenna according to claim 17, wherein the first and third frequencies are sufficiently close to provide a single unbroken usable bandwidth.

19. An antenna according to claim 17, wherein the second and fourth frequencies are sufficiently close to provide a single unbroken usable bandwidth.

20. An antenna according to claim 16, including a feed circuit, the feed circuit comprising an elongate signal line extending past the open ends of said slots.

21. An antenna according to claim 20, wherein said planar elements are separated by a non-conductive strip into which said slots open.

22. An antenna according to claim 21, including an insulating substrate, wherein said planar elements are on one side of said substrate and said signal line comprises a strip on the other side of the substrate and aligned with said non-conductive strip.
